(19) United States
(12) Patent Application Publication
(10) Pub. No.: US 2004/0177908 A1
(43) Pub. Date: Sep. 16, 2004

(54) Tire assembly

(76) Inventor: Tony Hsieh, Chang Hua (TW)

Correspondence Address: CHARLES E. BAXLEY, ESQUIRE, 59 John Street, Fifth Floor, New York, NY, 10038, US

(21) Appl. No.: 10/385,274

(22) Filed: Mar. 10, 2003

(51) Int. Cl. B60C 5/22; B60C 5/04; B60C 5/08; B60C 17/01

(52) U.S. Cl. 152/339.1; 152/340.1

(57) ABSTRACT

A tire assembly of the present invention is specially for off-road racing motorcycle or bicycle, wherein an inner tube and a sub-inner tube are defined between an outer tire and a wheel rim, the inner tube is inflated at normal pressure while a space between the outer tire and the sub-inner tube is inflated with the pressure applicable to racing purpose, such that, in case of running in low pressure, two annular lips of the outer tire will not fall off the wheel rim while it encounter a great impact, as a result, it prevent the inner tube from being squeezed to leak by the outer tire and the wheel rim and the broken of the cord fabric of the outer tire.

### BACK GROUND OF THE INVENTION

1. Field of the Invention

The present invention relates to a tire assembly, and more particularly to a tire for off-road racing motorcycle or bicycle, wherein an inner tube and a sub-inner tube are defined between the outer tire and the wheel rim, the inner tube is inflated at normal pressure while a chamber located between the outer tire and the sub-inner tube is inflated with the pressure applicable to racing purpose, such that, in case of running in low pressure, two annular lips of the outer tire will not fall off the wheel rim while it encounter a great impact, as a result, it prevent the inner tube from being squeezed to leak by the outer tire and the wheel rim and the broken of the cord fabric of the tire.

2. Description of the Prior Arts

Due to the road condition for racing is always bad, it is full of bumps and holes, slopes, and even sharp turns, the racers usually adjust the tire pressure of the motorcycle or the bicycle far below the normal one (normal tire pressure of motorcycle is 35 psi while 7-12 psi for racing normal tire pressure of bicycle is 45 psi while 15-30 psi for racing), in order to increase the touching surface between the outer tire and the ground, such that the power for gripping the ground is effectively increased. However, some drawbacks will also be caused.

Referring to FIG. 1, which shows a conventional tire assembly is comprised of a wheel rim 10, an inner tube 20 and an outer tire 30. The wheel rim 10 defines a receiving groove 11. The receiving groove 11 has two sidewalls and a valve hole 13 is defined through a bottom thereof so as to allow an inflation valve 22 to be engaged therewith. The inner tube 20 is interiorly defined with a space 21. An inner edge of the inner tube 20 is retained in the receiving groove 11 of the wheel rim 10. The inflation valve 22 is defined at the inner edge of the inner tube 20. The outer tire 30 is mounted upon the wheel rim 10 around the inner tire 20 such that each annular lip 31 of the outer tire 30 may engage with the respective projections 12 of the wheel rim 10. The above describes the construction of a conventional tire assembly, and here are the drawbacks of it as follows:

The space 21 of the inner tube 20 of a conventional tire assembly is to be normally inflated in order to support the outer tire 30 with enough pressure, furthermore, also by virtue of the tire pressure, the annular lips 31 of the outer tire 30 can be rigidly retained by the respective projections 12 at the two sides of the receiving groove 11 of the wheel rim 10. However, normally the tire of motorcycles or bicycles for off-road racing are often running in low pressure in order to increase the power for gripping the ground, accordingly, the inner tube 20 is inflated in low pressure and lacks of supporting force, as a result, when the tire assembly encounter a great impact force, the cord fabric in the annular lips 31 of the outer tire 30 is probably broken due to the inner tube 20 is in lower pressure and can not give enough supporting force to the outer tire 30, in addition, the annular lips 31 of the outer tire 30 can not be rigidly retained by the respective projections 12 at the two sides of the receiving groove 11 of the wheel rim 10, so the annular lips 31 of the outer tire 30 is subject to dropping off wheel rim 10 and the inner tube 20 will be squeezed to leak by the outer tire 30 and the wheel rim 10; besides, the inner tube 20 and the outer tire 30 are subject to punctured by pointed objects while riding on a bad conditioned road and the racing has to be interrupted.

Targeting at solving the above problems, all tire manufactures have resort to thicken the inner tube and outer tire and reinforce them, or change the material from butyl rubber to natural one, but all are not good effective.

The present invention has arisen to mitigate and/or obviate the afore-described disadvantages of the conventional tire assembly.

### SUMMARY OF THE INVENTION

The primary object of the prevent invention is to provide to a tire assembly comprising a wheel rim, an inner tube, a sub-inner tube and an outer tire, the inner tube and the sub-inner tube are defined between the outer tire and the wheel rim, the inner tube is inflated at normal pressure while a space located between the outer tire and the sub-inner tube is inflated with the pressure applicable to racing purpose, such that the tire of the present invention is capable of running in low pressure, and simultaneously taking advantage of the pressure of the inner tube to press the sub-inner tube and the outer tire firmly against the wheel rim, such that the inner tube will not fall off the wheel rim while it encounters a great impact, as a result, it prevent the inner tube from being squeezed to leak by the outer tire and the wheel rim, and the broken of the cord fabric of the outer tire.

Another object of the prevent invention is to provide a tire assembly having a normally inflated inner tube, which has enough force to support the sub-inner tube, so as to make the riding comfortable and enhance the cornering performance in case that the outer tire suffered an impact.

The further object of the present invention is to provide a tire assembly having a sub-inner tube defined between the inner tube and the outer tire, by such a device that it prevents the air from being leaked out of the tire in case the outer tire is punctured by pointed objects while riding on a bad conditioned road and ensures the continuation of the racing.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a cross sectional view of a conventional tire assembly;

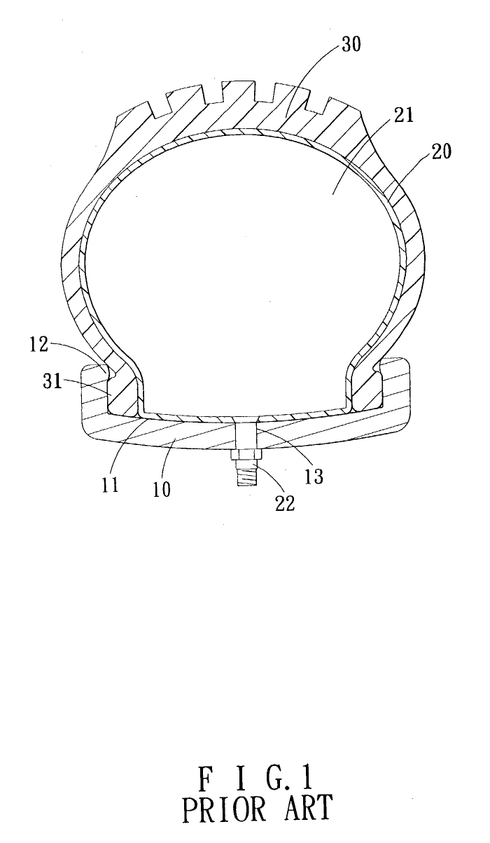

FIG. 2 is a fragmentary perspective view of a tire assembly in accordance with the present invention;

FIG. 3 is another fragmentary perspective view of a tire assembly in accordance with the present invention;

FIG. 4 is a cross sectional view in accordance with the present invention illustrating how the tire assembly being acted by external forces while riding in low pressure;

FIG. 5 is a cross sectional view in accordance with the present invention to show a specially made pneumatic needle inserting into the inner edge of the outer tire.

### DETAILED DESCRIPTION OF THE PREFERRED EMBODIMENTS

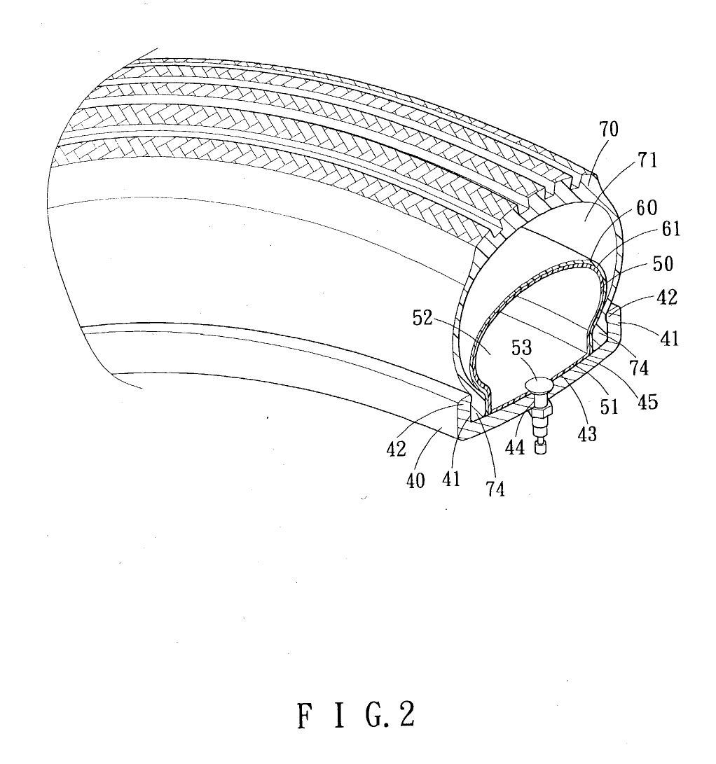

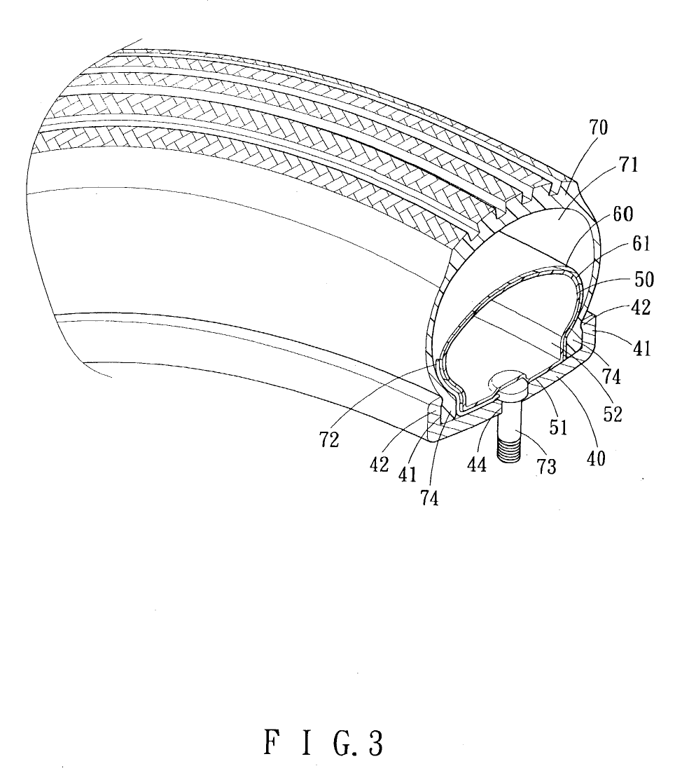

Referring to FIGS. 2-3, a tire assembly of the present invention comprises a wheel rim 40, an inner tube 50, a sub-inner tube 60 and an outer tire 70.

The wheel rim 40 includes two annular retaining walls 41 which extend radially and which are spaced-apart from each other. Each of the annular retaining walls 41 has a projection 42. The projections 42 of the annular retaining walls 41 are bent toward each other and are adapted to engage annular lips 74 of the outer tire 70. The wheel rim 40 defines a receiving groove 43 located between the annular retaining walls 41 and has a valve hole 44 defined through an inside bottom 45 thereof.

The inner tube 50 is mounted on the wheel rim 40 with an inner side 51 contacting the inside bottom 45 of the wheel rim 40 to define an inner space 52. The inner tube 50 has an inflation valve 53 which extends through the valve hole 44 at the receiving groove 43 of the wheel rim 40.

The sub-inner tube 60 is arc-shaped in cross section and has an inner edge 61 which is located above the inner tube 50.

The outer tire 70 is located above the sub-inner tube 60 in a to covering manner so as to define a space 71 therebetween, the space 71 is connected to a special valve 73 via a tube 72 (FIG. 3), the special valve 73 extends through the valve hole 44 at the receiving groove 43 of the wheel rim 40 and the annular lips 74 of the outer tire 70 is retained at the respective projection 42 of the receiving groove 43 of the wheel rim 40.

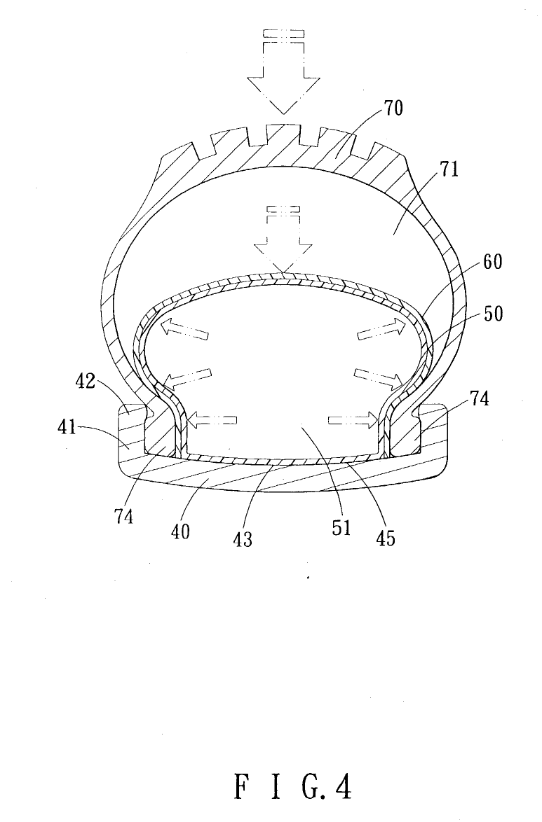

Referring now to FIG. 4, the space 71 between the outer tire 70 and the sub-inner tube 60 is inflated at a low pressure applicable to off-road racing while the inner tube 50 is normally inflated, such that the inner tube 50 has enough pressure to support the sub-inner tube 60 and the outer tire 70, so the annular lips 74 of the outer tire 70 will not fall off the wheel rim 40 while encountering a great impact, besides, when riding on a bad conditioned road, the outer tire 70 can keep working even it is punctured by pointed objects and the air is leaked out of the space 71 located between the outer tire 70 and the sub-inner tube 60, ensures the continuation of the racing; in addition, due to the inner tube 50 is normally inflated, it will press the sub-inner tube 60 and force the sub-inner tube 60 to press laterally outward so as to press the outer tire 70 firmly against the wheel rim 40, such that, in case of running in low pressure, the annular lips 74 of the outer tire 70 will not fall off the wheel rim 40 while encountering a great impact, as a result, it prevent the inner tube 50 from being squeezed to leak by the outer tire 70 and the wheel rim 40.

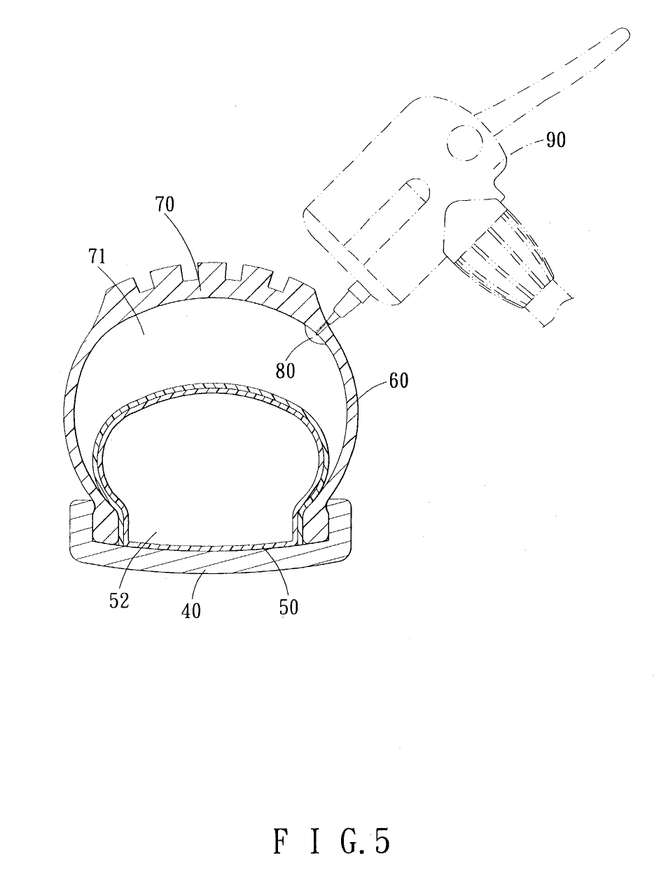

Referring further to FIG. 5, an inner edge of the outer tire 70 can be filled up with anti-leaking glue 80, initially inserting a specially made pneumatic needle 90 into the inner edge of the outer tire 70 where the anti-leaking glue 80 is filled and inflating the space 71 between the outer tire 70 and the sub-inner tube 60, then withdraw it out of there once finished inflating, in this way, the anti-leaking glue 80 will automatically fill up the hole caused by the needle 90 and prevent the air from leaking out of the space 71 located between the sub-inner tube 60 and the outer tire 70.

While we have shown and described the embodiments in accordance with the present invention, it should be clear to those skilled in the art that further embodiments may be made without departing from the scope of the present invention.

What is claimed is:

1. A tire assembly comprising:
a wheel rim including two annular retaining walls which extend radially and which are spaced-apart from each other, the wheel rim defining a receiving groove located between the annular retaining walls and having a valve hole defined through an inside bottom thereof, each of the annular retaining walls having a projection;
an inner tube mounted on the wheel rim with an inner side contacting the inside bottom of the wheel rim to define an inner space, the inner tube having an inflation valve which extends through the valve hole at the receiving groove of the wheel rim;
a sub-inner tube being arc-shaped in cross section and having an inner edge which is located above the inner tube;
an outer tire located above the sub-inner tube in a covering manner so as to define a space therebetween and having annular lips to engage with the projections of the receiving groove of the wheel rim.

2. The tire assembly as claimed in claim 1, wherein a portion of the inner edge of the outer tire is filled up with anti-leaking glue.

3. The tire assembly as claimed in claim 1, wherein the space located between the outer tire and the sub-inner tube is inflated by a specially made pneumatic needle.

4. The tire assembly as claimed in claim 1, wherein the space located between the tire and the sub-inner tube is inflated with a special valve.
